(19) United States
(12) Patent Application Publication
(10) Pub. No.: US 2002/0076047 A1
(43) Pub. Date: Jun. 20, 2002

(54) Information storage medium and information recording/reproducing apparatus

(76) Inventors: Hideo Ando, Hino-shi (JP); Hisashi Yamada, Yokohama-shi (JP); Tadashi Kojima, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/988,149

(22) Filed: Nov. 19, 2001

(30) Foreign Application Priority Data
Dec. 20, 2000 (JP) 2000-387665

(51) Int. Cl. H04N 7/167

(52) U.S. Cl. 380/203

(57) ABSTRACT

There is disclosed an apparatus in which a modulation method differs between information of a cryptograph associated information or distinction associated information region, and information of user data regions, and a channel bit length also differs.

### CROSS-REFERENCE TO RELATED APPLICATIONS

This application is based upon and claims the benefit of priority from the prior Japanese Patent Application No. 2000-387665 filed Dec. 20, 2000, the entire contents of which are incorporated herein by reference.

### BACKGROUND OF THE INVENTION

1. Field of the Invention

The present invention relates to information storage media such as package media (compact disk (CD), digital versatile disk (DVD), and the like), and an information recording/reproducing apparatus. The present invention relates particularly to a technique which can prevent an illicit action such as an illicit copy of user data which is recorded in the package media and whose copyright is protected.

2. Description of the Related Art

For example, in a field of DVD video, contents information (user data) is enciphered and recorded in a disk in many cases. Moreover, key information for deciphering the information is recorded in a specified position of the disk.

When the contents information is reproduced in a DVD video system, the key information recorded in the specified position on the disk is reproduced by a reproduction apparatus. The reproduction apparatus decodes the enciphered contents information using the reproduced key information.

In a conventional technique, the key information and the contents information have the same modulation method and have an equal channel bit length. Therefore, as a problem, even when the position on the disk with the key information recorded therein is not known, an illicit copy is enabled by wholly copying (disk copy) all information on the disk to another medium.

### BRIEF SUMMARY OF THE INVENTION

To solve the problem, according to an aspect of the present invention, there are provided an information storage medium including an illicit use preventing information by which an illicit use (reproduction/use) can be prevented even with copying (copy into the disk or a memory) of whole information on a disk or whole transmission information, and information storage/reproduction method and apparatus.

In an embodiment of the present invention, a modulation method differs between key information, copy control information, or copy associated information/cryptography associated information, and contents information (user data information), or a channel bit length also differs therebetween.

That is, a modulation system or a channel bit length is changed between the key information, copy control information, or copy associated information/cryptography associated information, and the contents information (user data information).

Moreover, in an information reproduction apparatus in the present embodiment, reproduction of information having different modulation systems and channel bit lengths is enabled. On the other hand, an information recording/reproducing apparatus is constituted such that only information having one type of modulation system and channel bit length with respect to the user data can be recorded into the information storage medium.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory view showing one embodiment of a storage medium according to the present invention.

FIG. 2 is an explanatory view showing a constitution of a decoder according to the present invention.

FIG. 3 is a diagram showing a modulation system of a signal form according to the present invention.

FIG. 4 is a constitution explanatory view showing a signal extracting portion of a reproduction apparatus according to the present invention.

FIG. 5 is a constitution explanatory view showing another embodiment of the present invention.

FIG. 6 is a constitution explanatory view of a recording system in a storage/reproduction apparatus according to the present invention.

### DETAILED DESCRIPTION OF THE INVENTION

Embodiments of the present invention will be described hereinafter with reference to the drawings.

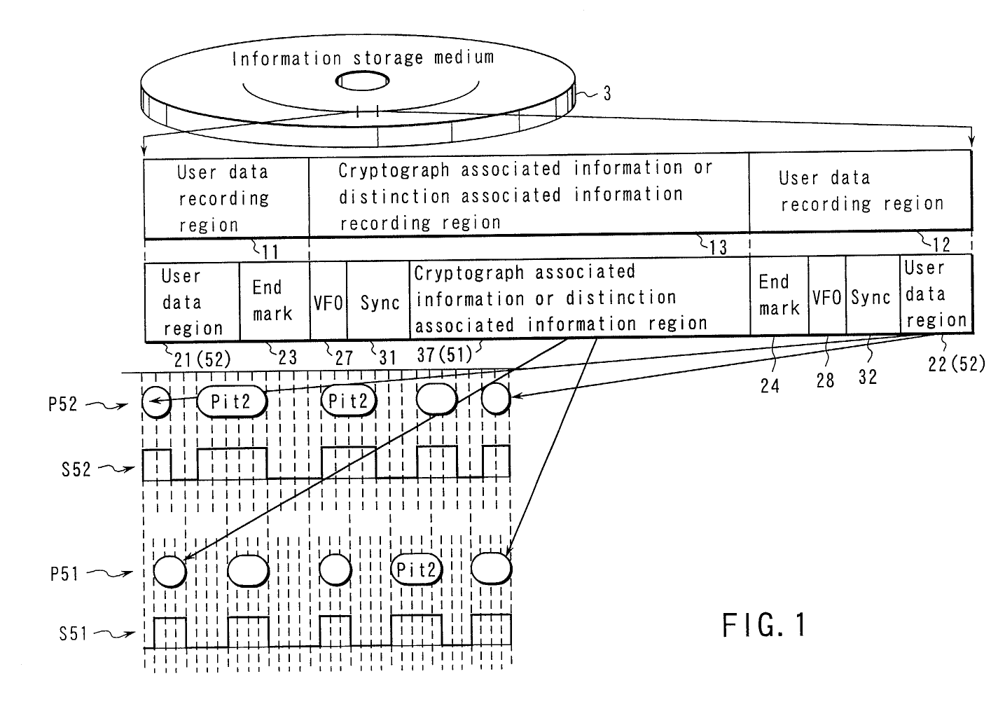

FIG. 1 shows one embodiment of an information storage medium of the present invention. Reference numeral 3 denotes an information storage medium for use, for example, in a DVD video system. User data recording regions 11, 12, and a cryptograph associated information or distinction associated information recording region 13 are serially (alternately) disposed on the same track on the information storage medium 3.

End mark information 23, 24 are recorded in respective ends of the user data recording regions 11, 12, and the cryptograph associated information or distinction associated information recording region 13. This facilitates a boundary distinction between the respective recording regions. Moreover, variable frequency oscillators (VFO) 27, 28 as signals for synchronization and synchronous signals for distinguishing an end of data Sync 31, 32 are disposed in tops of the respective recording regions 11, 13, 12. The top of the recording region 11 is not shown in the drawing.

Enciphered audio video (AV) contents information and/or management information (i.e., enciphered information 52) are recorded in user data regions 21, 22 in the user data recording regions 11, 12. Even when the enciphered information 52 is reproduced by a reproduction apparatus, the information cannot be deciphered as it is. The management information is information referred to by the reproduction apparatus, when the AV contents information is reproduced.

Key information 51 for decoding (deciphering) the enciphered AV contents information is recorded in a cryptograph associated information or distinction associated information region 37 in the cryptograph associated information or distinction associated information recording region 13.

Additionally, VOF and Sync also exist in the user data recording region 11, but are omitted in the drawing. Moreover, the end mark also exists in the user data recording region 11, but is omitted in the drawing.

The user data recording region, and the cryptograph associated information or distinction associated information recording region repeatedly arrive in a time direction (reproduction direction). Here, a content of the key information recorded in the cryptograph associated information or distinction associated information recording region 37 may differ each time or cyclically, or may be the same regarding one disk.

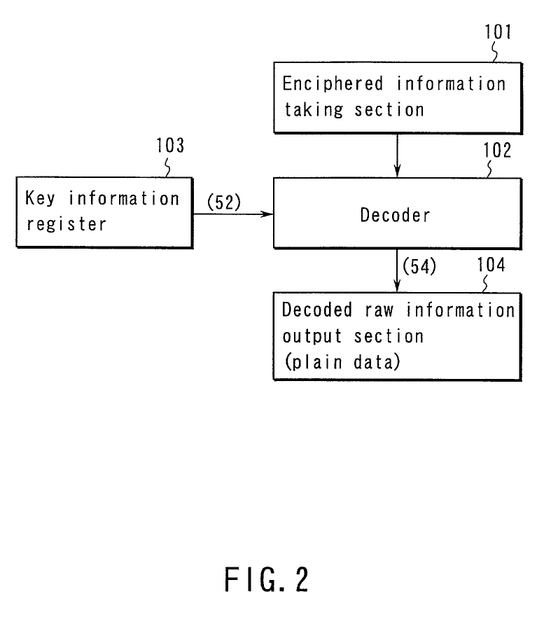

FIG. 2 shows a signal processor in the reproduction apparatus for reproducing the information of the information storage medium. The enciphered information 52 is inputted into a decoder 102 via an enciphered information taking section 101, and the key information 51 is inputted into a decoder 102 via a key information register 103. Thereby, plain raw information 54 is obtained from the decoder 102, and derived from a raw information output section 104.

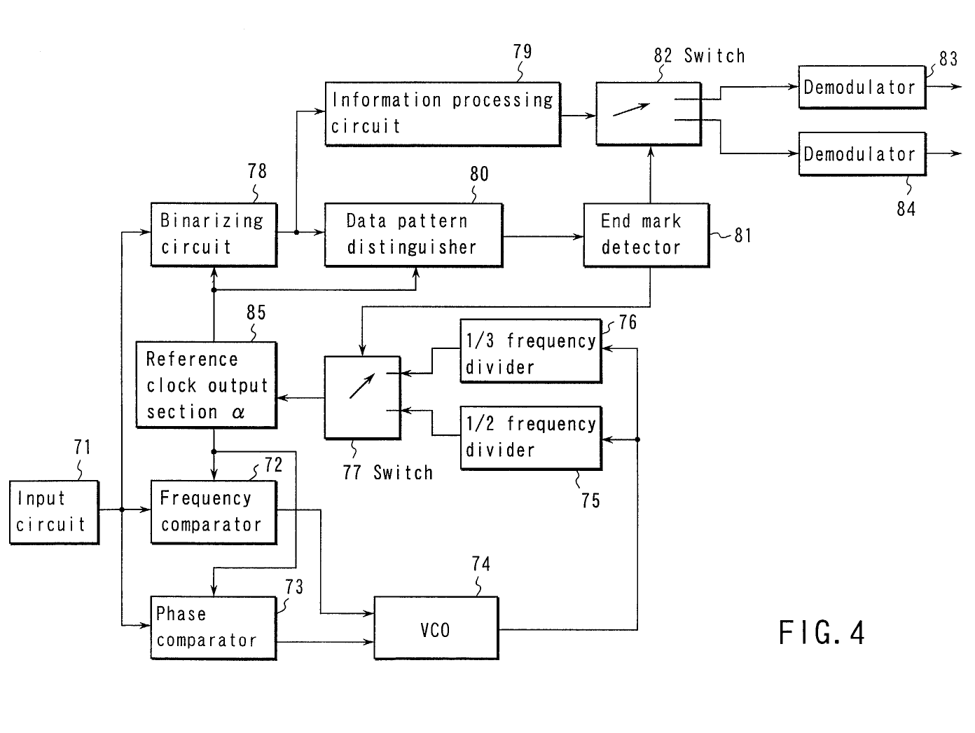

The key information demodulated by a demodulator (83 of FIG. 4) described later is stored in the key information register 103. The enciphered information demodulated by the demodulator (84 of FIG. 4) described later is stored in the enciphered information taking section 101.

Here, turning back to FIG. 1, a characteristic of a storage signal will be described. In the present embodiment, a large characteristic lies in that a modulation method and channel bit length of the data recorded in the user data regions 21, 22 and cryptograph associated information or distinction associated information region 37 are varied.

Particularly the channel bit length of the information of the cryptograph associated information or distinction associated information region 37 is set to be shorter than the channel bit length in the user data regions 21, 22. Furthermore, both the channel bit lengths are set in a relation of non-integer multiple.

If the channel bit length of the information of the cryptograph associated information or distinction associated information region 37 is n-times (n is an integer value) the channel bit length of the information of the user data regions 21, 22, the information of the cryptograph associated information or distinction associated information region 37 can be recorded with one type of recording circuit for recording the user data regions 21, 22 with an additionally writable or rewritable information recording/reproducing apparatus. In this case, an object of the present embodiment cannot be achieved. Therefore, in the present embodiment, the relation of non-integer multiple is set.

FIG. 1 shows a state of a pit arrangement P52 of the cryptograph associated information or distinction associated information region 37, and a state of a signal S52 corresponding to the pit arrangement P52. In comparison, a state of a pit arrangement P51 of the user data region, and a state of a signal S51 corresponding to the pit arrangement P51 are shown. The channel bit lengths have a relation of non-integer multiple.

Moreover, in the embodiment of FIG. 1, the key information is recorded in the cryptograph associated information or distinction associated information region 37. However, the present invention is not limited to this embodiment, and includes the following techniques.

That is, (a) a medium is an additionally writable or rewritable information storage medium. Moreover, the copy control information is recorded in the cryptograph associated information or distinction associated information region 37, and indicates information of “copy prohibited”. In this case, a reproduction apparatus side can use the copy control information as information by which any one of “prohibition of decipherment (outputting the enciphered information as it is)”, “prohibition of reproduction”, and “prohibition of output” is set. Furthermore, (b) type distinction information of the information storage medium may be recorded in the cryptograph associated information or distinction associated information region 37. In this case, it is judged on the reproduction apparatus side that the medium to be reproduced is an information storage medium for exclusive use in reproduction, and then only important contents information is decoded and outputted. However, when other storage media are judged, the type distinction information can be used as information for setting either “prohibition of reproduction” or “prohibition of output”.

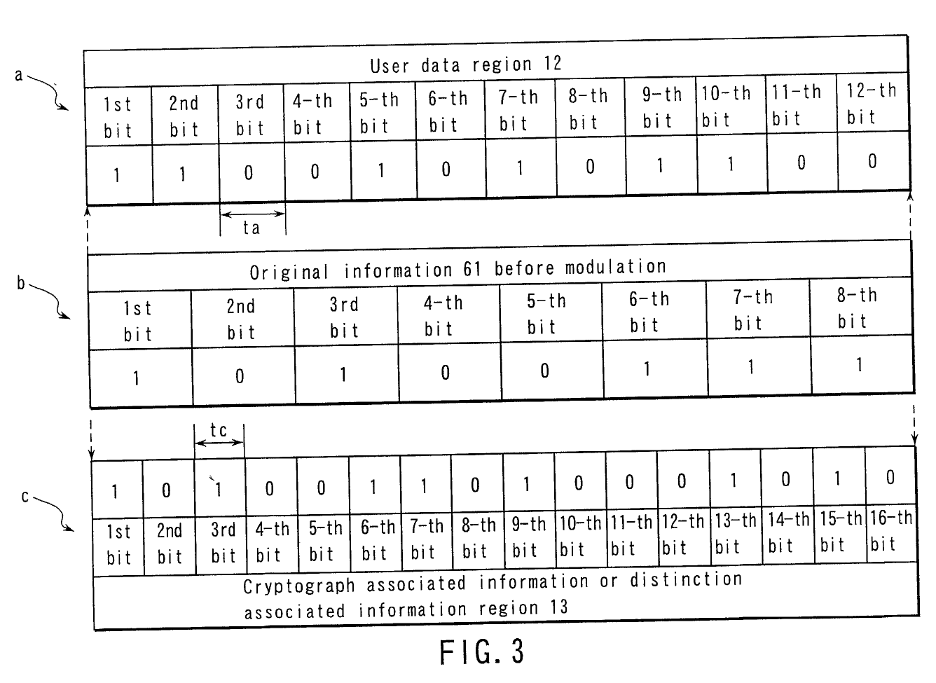

The modulation method and channel bit length of the data recorded in the user data regions 21, 22 and cryptograph associated information or distinction associated information region 37 will be described with reference to FIG. 3. An 8/16 modulation is employed as the modulation system with respect to the data of the cryptograph associated information or distinction associated information region 37, and 8 bits of original information 61 before the modulation (see character b of FIG. 3) are converted to 16 bits (character c of FIG. 3). On the other hand, a (1.7 modulation) is employed with respect to the data of the user data region 12, and 8 bits of the original information 61 before the modulation (see character b of FIG. 3) are converted to 12 bits (see character a of FIG. 3).

As described above, according to the method of the present invention, a bit number after conversion of the original information differs with the cryptograph associated information or distinction associated information 13 and user data 12. Therefore, even when the channel bit length of the original information 61 before the modulation is the same, the channel bit length after the modulation differs in both the regions (user data regions 21, 22 and cryptograph associated information or distinction associated information region 37).

The information reproduction apparatus for reproducing the information storage medium shown in FIG. 1 or an information reproduction circuit in the information recording/reproducing apparatus will be described with reference to FIG. 4. A very high frequency clock is outputted in an output of a voltage control oscillator (VCO) 74 which constitutes a phase synchronization loop circuit. When the information of the user data recording region 11 or 12 is reproduced, an output signal of a ⅓ frequency divider 76 is passed through a switch 77 and inputted into a reference clock output section 85, so that a reference clock a is formed. On the other hand, when the information of the cryptograph associated information or distinction associated information recording region 13 is reproduced, an output signal of a ½ frequency divider 75 is passed through the switch 77 and inputted into the reference clock output section 85, so that the reference clock α is formed.

An input signal from an input circuit 71 read from the disk is binarized by a binarizing circuit 78. An output of the binarizing circuit 78 is inputted into a data pattern distinguisher 80. In the data pattern distinguisher 80, the reference clock α is used to reproduce data pattern. The reproduced data pattern information is inputted into an end mark detector 81. The end mark detector 81 detects the end marks 23, 24 from the data pattern and gives a detection signal to the switch 77 and a switch 82. Thereby, the switch 77 is changed so that the frequency of the reference clock α fits the next channel bit length.

The reference clock α is used as a sampling clock of the binarizing circuit 78 and data pattern distinguisher 80. A binarized signal outputted from the binarizing circuit 78 is inputted into an information processing circuit 79. In the information processing circuit 79, the synchronous signal is removed, and a frame is extracted. The extracted frame (modulated signal) is inputted into a demodulator 83 or 84 via the switch 82. The demodulator 83 decodes the cryptograph associated information or the distinction associated information, that is, performs 16/8 demodulation. Moreover, the demodulator 84 demodulates the contents information. The switch 82 selects the demodulator 83 or 84 based on a switch control signal from the end mark detector 81. When the information of the user data recording region 11 or 12 is reproduced, the demodulator 84 is selected. When the information of the cryptograph associated information or distinction associated information recording region 13 is reproduced, the demodulator 83 is selected.

When the information of the cryptograph associated information or distinction associated information recording region 13 and user data recording regions 11, 12 are reproduced, the frequency of the reference clock a is changed in accordance with each information. This is a large characteristic of the information reproduction circuit.

The information storage medium 3 has been described as a medium for exclusive use in reproduction with reference to FIGS. 1 to 4. The present invention is also applicable to the additionally writable or rewritable information storage medium as another embodiment.

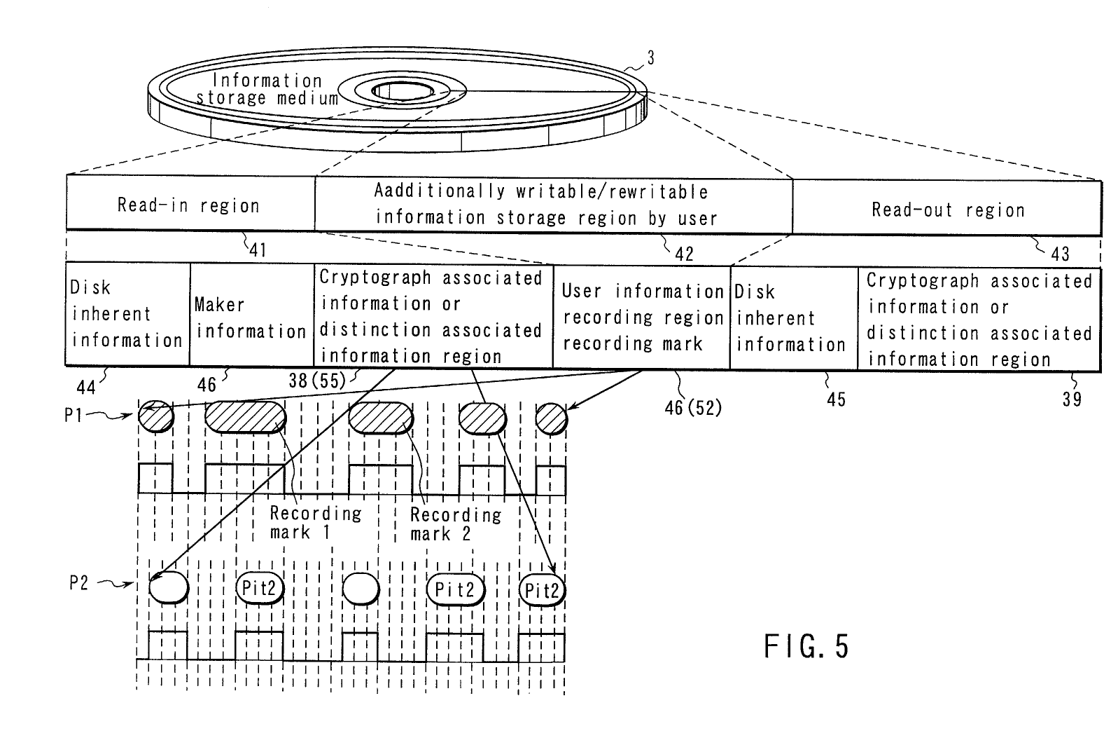

FIG. 5 shows an example in which the present invention is applied to the additionally writable or rewritable information storage medium 3. According to a user's setting, a recording apparatus records the information, when a recording mark string P1 is formed in an additionally writable/rewritable information storage region 42.

On the other hand, a read-in region 41 and a read-out region 43 exist in an innermost peripheral portion and an outermost peripheral portion of the information storage medium 3, respectively. The information is recorded in the form of a pit string P2 beforehand in the region, and cannot be rewritten. A cryptograph associated information or distinction associated information region 38 exists in the read-in region 41 or the read-out region 43. Key information or identification information 55 is recorded in the region. The key information or identification information 55 is used to decode enciphered information 52 recorded in a user information recording region 46. Also in this case, as shown in FIG. 3, the modulation system or the channel bit length of the information of the cryptograph associated information or distinction associated information region 38 and user information recording region 46 is set to differ.

Also in the present embodiment, when the reproduction processor decodes the information, the circuits of FIGS. 4 and 2 described above are applied.

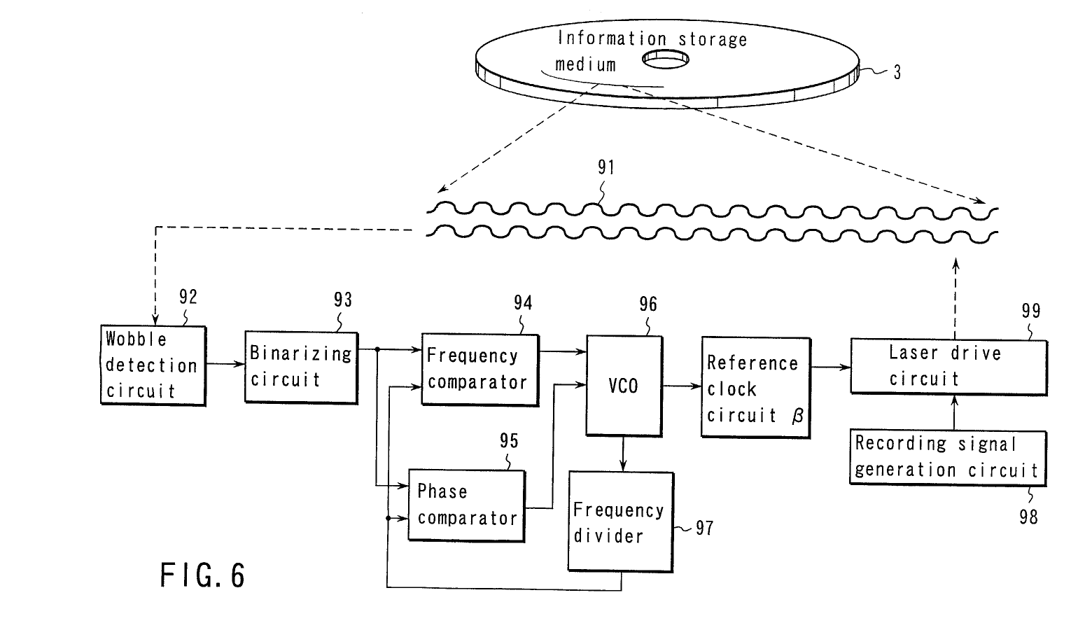

FIG. 6 shows a circuit in the information recording/reproducing apparatus which handles the additionally writable or rewritable information storage medium 3. A wobble 91 exists along a track in the additionally writable or rewritable information storage medium 3. A reproduction signal optically read and converted to an electric signal is inputted into a wobble detection circuit 92. The wobble detection circuit 92 filters and extracts a wobble signal, and supplies the signal to a binarizing circuit 93. A binarized signal outputted from the binarizing circuit 93 is inputted into a frequency comparator 94 and phase comparator 95. An oscillation signal of a voltage control oscillator (VCO) 96 is frequency-divided by a frequency divider 97 and given to the frequency comparator 94 and phase comparator 95. A frequency error signal obtained from the frequency comparator 94 and a phase error signal obtained from the phase comparator 95 are used as an oscillation frequency control signal of the VCO 96. Thereby, an oscillation output of the VCO 96 forms a signal synchronized with a frequency and phase of the wobble signal, and is supplied to a reference clock circuit. A reference clock β generated here is supplied to a laser drive circuit 99. Moreover, the reference clock β is modulated based on a recording signal supplied from a recording signal generation circuit 98, and forms a laser light, and the laser light is outputted.

As shown in FIG. 6, different from a reproduction circuit system of FIG. 4, only the reference clock β is generated in a recording circuit system. Only one type of frequency exists in the reference clock β. The frequency is matched with a frequency for recording/reproducing the recording mark string P1 in the additionally writable/rewritable information storage region 42, and does not form a frequency corresponding to the channel bit length of the cryptograph associated information or distinction associated information region 38.

Therefore, in the recording circuit system in the information recording/reproducing apparatus which handles the additionally writable or rewritable information storage medium 3, it is impossible to record the information of the cryptograph associated information or distinction associated information region 38.

As described above, this embodiment is applied to the information storage medium in which first information including at least one type of information from copy associated information, cryptography associated information, and identification information, and second information different from the first information and used by a user are recorded. Here, a first reference length (channel bit length) is defined in the information storage medium (region) with the first information recorded therein, and reproduction signal information regarding the first information is recorded at an interval which is integer times as long as the first reference length. Moreover, a second reference length (channel bit length) is defined in the information storage medium (region) with the second information recorded therein, and the reproduction signal information regarding the second information is recorded at an interval which is integer times as long as the second reference length. Furthermore, the first reference length and the second reference length are set to be different from each other.

Moreover, in the recording/reproducing apparatus with respect to the additionally writable or rewritable information storage medium, only a function for recording the information in accordance with the second channel bit length is disposed in an additionally writable or rewritable information recording region. As a result, it is impossible to record the information recorded with the first channel bit length in the additionally writable or rewritable information recording region.

Moreover, according to the present invention, there can be provided an information reproduction apparatus which reproduces the first information with respect to the information storage medium, and performs at least one processing of reproduction control of the second information, decipherment of the second information, and output control of the second information based on a content of the first information.

Thereby, medium identification information and copy control information can be applied as the first information which cannot be recorded by the recording/reproducing apparatus with respect to the additionally writable or rewritable information storage medium. Moreover, reproduction of the second information, or output of the second information can be prohibited based on the content of the first information. Furthermore, since the first information cannot be copied, high reliability can be secured with respect to the first information.

Moreover, the key information for decipherment can be applied as the first information which cannot be recorded by the recording/reproducing apparatus with respect to the additionally writable or rewritable information storage medium. This can strongly prevent copy prohibited information from being further copied to another medium or region. That is, even if the first information is forcibly copied to the recording region in the additionally writable or rewritable information storage medium, the key information cannot accurately be copied because of different channel bit lengths. Therefore, in an illicit action, wrong key information is copied. Even if the key information is used to reproduce the second information in the reproduction apparatus, accurate decoding (decipherment processing) cannot be performed.

Additionally, the present invention is not limited to the aforementioned embodiments. In the above description, the disk is an object as the information storage medium, but of course the present invention can also be applied to a signal medium transmitted by radio or via a cabled transmission path. Moreover, the present invention can also be applied to an apparatus for transmitting the signal and a receiving apparatus and method. Considering signal transmitting and receiving apparatuses, there are provided an apparatus for transmitting an information string shown in FIGS. 1 and 5 onto the transmission path (FIGS. 2, 4), or an apparatus for taking the information string from the transmission path (FIGS. 2, 4).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An information storage medium in which first information including at least one type of information selected from a group consisting of copy associated information, cryptography associated information, and identification information, and second information different from said first information and used by a user are recorded,
wherein a first reference channel bit length is defined in a region in which said first information is recorded,
a second reference channel bit length is defined in a region in which said second information is recorded, and
said first reference channel bit length and said second reference channel bit length are different from each other.

2. An information storage medium in which first information including at least one type of information selected from a group consisting of copy associated information, cryptography associated information, and identification information, and second information different from said first information and used by a user are recorded,
wherein a first reference channel bit length is defined in a region in which said first information is recorded, and a signal regarding said first information is recorded at an interval which is integer times as long as said first reference channel bit length,
a second reference channel bit length is defined in a region in which said second information is recorded, and a signal regarding said second information is recorded at an interval which is integer times as long as said second reference length, and
said first reference channel bit length and said second reference channel bit length are different from each other.

3. The information storage medium according to claim 1, wherein an arrangement order of said first information and the second information in a track direction is set so that the first information and the second information are alternately arranged and the second information arriving next to the first information is decoded based on a reproduced content of the first information.

4. The information storage medium according to claim 2, wherein an arrangement order of said first information and the second information in a track direction is set so that the first information and the second information are alternately arranged and the second information arriving next to the first information is decoded based on a reproduced content of the first information.

5. The information storage medium according to claim 1, wherein said first information exists in a top or a tail end of said second information, and the second information is all decoded based on a reproduced content of said first information.

6. The information storage medium according to claim 2, wherein said first information exists in a top or a tail end of said second information, and the second information is all decoded based on a reproduced content of said first information.

7. An information reproduction apparatus for accessing an information storage medium in which first information including at least one type of information selected from a group consisting of copy associated information, cryptography associated information, and identification information, and second information different from said first information and used by a user are recorded, a first reference channel bit length is defined in a region with said first information recorded therein, a second reference channel bit length is defined in a region with said second information recorded therein, and said first reference channel bit length and said second reference channel bit length are different from each other, said information reproduction apparatus comprising:
a reproduction section for reproducing said first information; and
a processor for performing a processing of at least one of reproduction control of said second information, decipherment of said second information, and output control of said second information based on a reproduced content of said first information.

8. The information reproduction apparatus according to claim 7, wherein said first information and said second information are information reproduced from a recording medium.

9. The information reproduction apparatus according to claim 7, further comprising:
means for supplying said first information and said second information to a phase synchronization circuit loop, and changing a frequency to a frequency of said phase synchronization circuit loop in accordance with the channel bit lengths of said first and second information; and
means for inputting a clock from said phase synchronization circuit loop for sampling into a binarizing circuit to which said first and second information are applied.

10. An information reproduction apparatus comprising:
a reproduction section for receiving an information string which includes first information including at least one type of information selected from a group consisting of copy associated information, cryptography associated information, and identification information, and second information different from said first information and used by a user and in which a signal of a first reference channel bit length is defined for said first information, a signal of a second reference channel bit length is defined for said second information, and said first reference channel bit length and said second reference channel bit length are different from each other, and for reproducing said first information; and
a processor for receiving said information string, and performing a processing of at least one of reproduction control of said second information, decipherment of said second information, and output control of said second information based on a reproduced content of said first information.

11. The information reproduction apparatus according to claim 8, wherein said information string is received via a transmission path.
